(19) United States
(12) Patent Application Publication
(10) Pub. No.: US 2016/0119741 A1
(43) Pub. Date: Apr. 28, 2016

(54) REMOTE CONTROL SYSTEM AND SIGNAL CONVERTER OF THE SAME

(71) Applicant: GRAND MATE CO., LTD., Taichung City (TW)

(72) Inventors: CHUNG-CHIN HUANG, Taichung City (TW); CHIN-YING HUANG, Taichung City (TW); HSIN-MING HUANG, Taichung City (TW); HSING-HSIUNG HUANG, Taichung City (TW); YEN-JEN YEH, Taichung City (TW); KUAN-CHOU LIN, Taichung City (TW); YU-CHIN TSAI, Taichung City (TW)

(21) Appl. No.: 14/520,874

(22) Filed: Oct. 22, 2014

(51) Int. Cl. H04W 4/00; H04L 29/02; H04L 12/28

(52) U.S. Cl. CPC H04W 4/008; H04L 12/2816; H04L 29/02; H04W 88/08

(57) ABSTRACT

A remote control system includes a control signal source, a signal converter, a first electric appliance, a second electric appliance, and a third electric appliance. The control signal source sends out WiFi signals which contain control commands. The signal converter converts the WiFi signals into Bluetooth signals, RF signals, or IR signals, wherein these signals are respectively transmitted to a Bluetooth transceiver, an RF transceiver, and an IR transmitter which are respectively installed in the electric appliances to operate the electric appliances.

### BACKGROUND OF THE INVENTION

1. Technical Field

The present invention relates generally to remote control, and more particularly to a remote control system which has a converter capable of converting WiFi signals into Bluetooth signals.

2. Description of Related Art

Bluetooth technology is commonly applied in electric appliances nowadays, whereby a user is able to control an electric appliance with an electronic device which has Bluetooth communication capability. More specifically, the conventional way to control wirelessly via Bluetooth communication technology includes providing a Bluetooth controller in an electric appliance, and sending Bluetooth signals which contain control commands to the Bluetooth controller with an electronic device (e.g., a smartphone). In this way, the electric appliance can be controlled accordingly. Obviously, it is convenient to control such electric appliances.

However, the coverage of Bluetooth communication is quite small; for example, an electric appliance located farther than 10 meters would not be able to be controlled via Bluetooth. What's more, Bluetooth signals would be greatly attenuated if an electric appliance and its corresponding electronic device are separated by a wall, and in such cases, the performance of controlling would be severely affected. Therefore, the usage of Bluetooth communication technology is still limited in the foregoing field.

### BRIEF SUMMARY OF THE INVENTION

In view of the above, the primary objective of the present invention is to provide a remote control system, which is able to convert WiFi signals of wider coverage into Bluetooth signals to control electric appliances with a Bluetooth controller.

The present invention provides a remote control system, which includes a control signal source, a signal converter, and a first electric appliance. The control signal source generates and sends out WiFi signals. The signal converter includes a WiFi transceiver, a converting module electrically connected to the WiFi transceiver, and a Bluetooth transceiver electrically connected to the converting module, wherein the WiFi transceiver receives the WiFi signals from the control signal source, and the converting module converts the WiFi signals into corresponding Bluetooth signals to be sent out by the Bluetooth transceiver. The first electric appliance includes a Bluetooth transceiving circuit and a first control circuit electrically connected to the Bluetooth transceiving circuit, wherein the Bluetooth transceiving circuit receives the Bluetooth signals from the Bluetooth transceiver, and the first control circuit controls the first electric appliance to perform functions according to the received Bluetooth signals.

The present invention also provides a signal converter, which includes a WiFi signal transceiver, a converting module, and a Bluetooth transceiver. The WiFi signal transceiver receives WiFi signals. The converting module is electrically connected to the WiFi transceiver, wherein the converting module converts the WiFi signals into corresponding Bluetooth signals to be sent out. The Bluetooth transceiver is electrically connected to the converting module, wherein the Bluetooth transceiver transmits the Bluetooth signals to a first electric appliance.

With the remote control system and the signal converter, WiFi signals can be converted into Bluetooth signals first and then transmitted to a corresponding electric appliance which is located at a farther distance.

### BRIEF DESCRIPTION OF THE SEVERAL VIEWS OF THE DRAWINGS

The present invention will be best understood by referring to the following detailed description of some illustrative embodiments in conjunction with the accompanying drawings, in which

FIG. 1 is a schematic diagram of a first preferred embodiment of the present invention;

FIG. 2 is a block diagram of the signal converter of the first preferred embodiment of the present invention;

FIG. 3 is a block diagram of the Bluetooth controller of the first preferred embodiment of the present invention;

FIG. 4 is a block diagram of the RF controller of the first preferred embodiment of the present invention;

FIG. 5 is a block diagram of the IR controller of the first preferred embodiment of the present invention; and

FIG. 6 is a schematic diagram of a second preferred embodiment of the present invention.

### DETAILED DESCRIPTION OF THE INVENTION

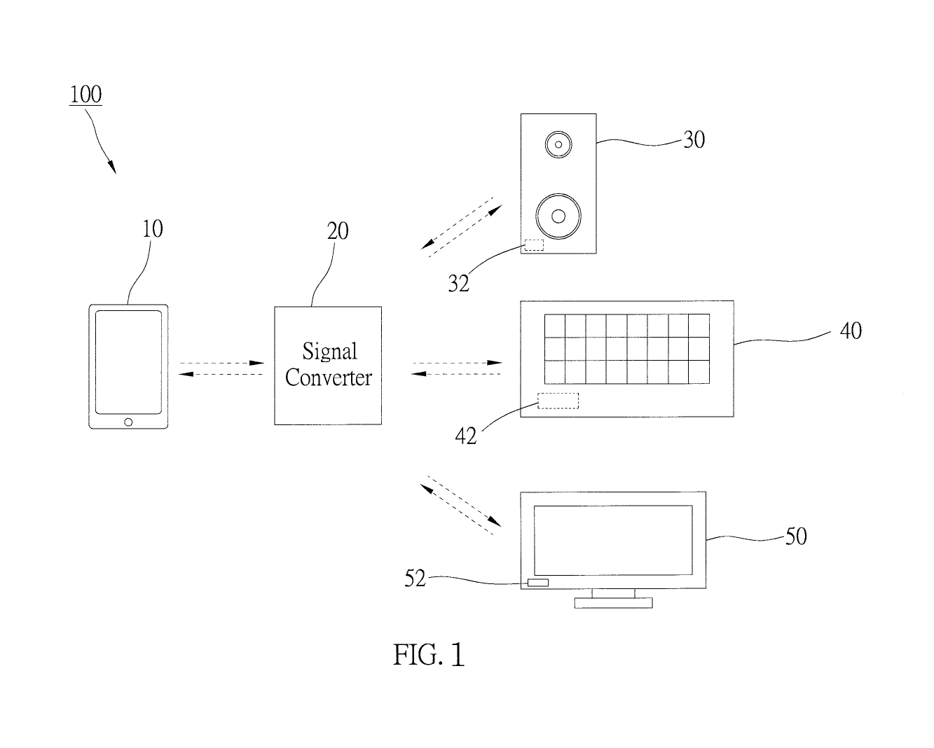

As shown in FIG. 1 to FIG. 5, a remote control system 100 of the first preferred embodiment of the present invention includes a control signal source, a signal converter 20, a first electric appliance, a second electric appliance, and a third electric appliance.

In the first preferred embodiment, the control signal source is a smartphone 10, which is installed with an application for users to input control commands (e.g., turning on/off) to control the electric appliances, wherein the application encapsulates the inputted control commands into WiFi signals to be sent out. In practice, the control signal source can be, of course, a computer or other devices which are capable of sending out WiFi signals.

The first electric appliance is a stereo set 30, the second electric appliance is an air conditioner 40, and the third electric appliance is a TV 50, wherein the stereo set 30 can be controlled via Bluetooth, while the air conditioner 40 and the TV 50 can be respectively controlled via RF (radio frequency) and IR (infrared) signals.

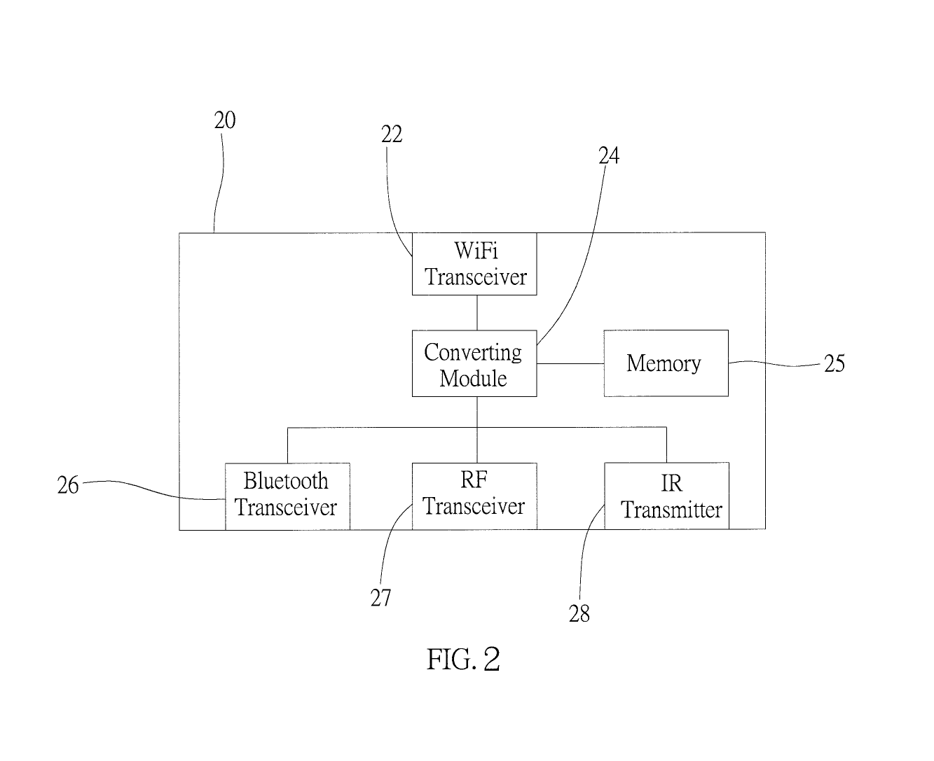

As shown in FIG. 2, the signal converter 20 includes a WiFi transceiver 22, a converting module 24, a memory 25, a Bluetooth transceiver 26, an RF transceiver 27, and an IR transmitter 28.

The WiFi transceiver 22 receives WiFi signals sent from the smartphone 10. The converting module 24 is electrically connected to the WiFi transceiver 22, while the memory 25 is electrically connected to the converting module 24, wherein the memory 25 is stored with a plurality of ID codes which respectively corresponds to each electric appliance. In addition, the memory 25 is also stored with a plurality of classification codes of signals, including Bluetooth, RF, IR, etc., which are receivable by each electric appliance.

The WiFi transceiver 22 transmits the received WiFi signals to the converting module 24, wherein the converting module 24 reads data in the memory 25 as a reference, and the WiFi signals are then accordingly converted into Bluetooth signals, RF signals, or IR signals to be sent out.

The Bluetooth transceiver 26, the RF transceiver 27, and the IR transmitter 28 are electrically connected to the converting module 24, respectively, and they respectively transmit the Bluetooth signals, the RF signals, and the IR signals provided by the converting module 24 to the corresponding electric appliance.

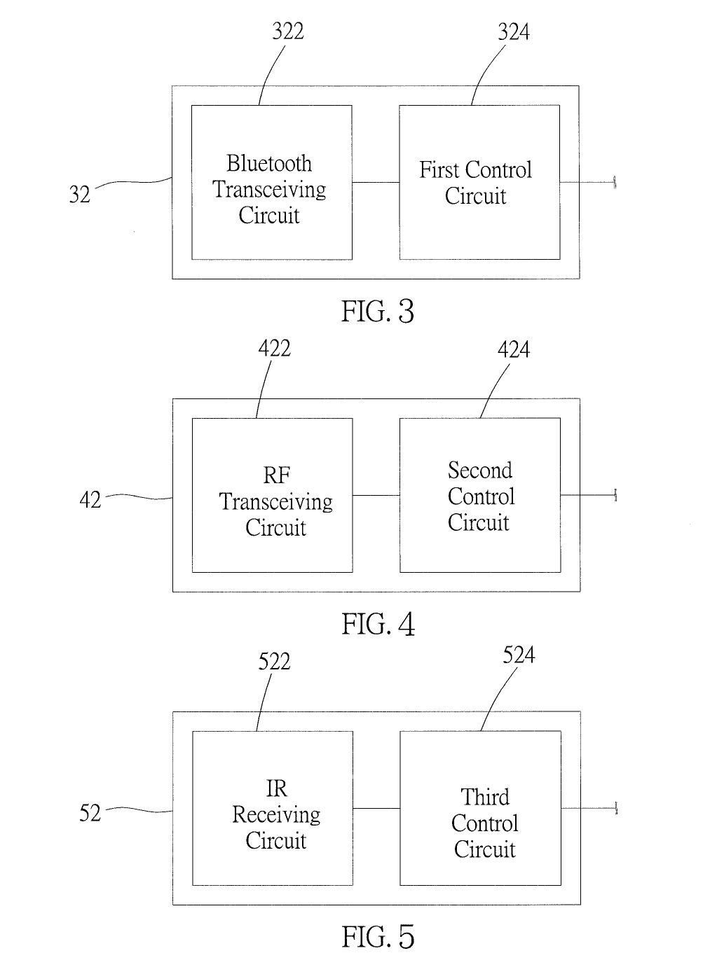

As shown in FIG. 3, the stereo set 30 is installed with a Bluetooth controller 32, wherein the Bluetooth controller 32 includes a Bluetooth transceiving circuit 322 and a first control circuit 324. The Bluetooth transceiving circuit 322 receives the Bluetooth signals transmitted from the Bluetooth transceiver 26. The first control circuit 324 is electrically connected to the Bluetooth transceiving circuit 322 to control the stereo set 30 to perform certain functions according to the Bluetooth signals received by the Bluetooth transceiving circuit 322.

As shown in FIG. 4, the air conditioner 40 is installed with an RF controller 42, wherein the RF controller 42 includes an RF transceiving circuit 422 and a second control circuit 424. The RF transceiving circuit 422 receives the RF signals transmitted from the RF transceiver 27. The second control circuit 424 is electrically connected to the RF transceiving circuit 422 to control the air conditioner 40 to perform certain functions according to the RF signals received by the RF transceiving circuit 422.

As shown in FIG. 5, the TV 50 is installed with an IR controller 52, wherein the IR controller 52 includes an IR receiving circuit 522 and a third control circuit 524. The IR receiving circuit 522 receives the IR signals transmitted from the IR transmitter 28. The third control circuit 524 is electrically connected to the IR receiving circuit 522 to control the TV 50 to perform certain functions according to the IR signals received by the IR receiving circuit 522.

To correspondingly convert the received WiFi signals which contain the control commands into the Bluetooth signals, the RF signals, or the IR signals with the signal converter 20, the remote control system 100 is set up to control each of the electric appliances in the following way.

First, the Bluetooth transceiving circuit 322 of the stereo set 30 transmits the Bluetooth signals which contain all kinds of control information, such as turning on/off, and the corresponding ID code of the stereo set 30 to the Bluetooth transceiver 26 of the signal converter 20. After receiving and recording the Bluetooth signals, the Bluetooth transceiver 26 stores the ID codes contained in the Bluetooth signals into the memory 25 through the converting module 24.

After that, the converting module 24 stores the classification code of the received signals (i.e., Bluetooth signals) into the memory 25, and establishes a connection between the classification code and the ID code contained in the received Bluetooth signals. Finally, the converting module 24 encapsulates the ID code and the control information into WiFi signals, which are then transmitted to the smartphone 10 through the WiFi transceiver 22.

And then, all kinds of the control information of the stereo set 30, such as turning on/off, are shown on a display of the smartphone 10 for a user to select therefrom. Once selected, the smartphone 10 encapsulates the corresponding control command and the ID code of the stereo set 30 into WiFi signals to be sent out. Furthermore, after the WiFi transceiver 22 receives the WiFi signals and then transfers to the converting module 24, the converting module 24 extracts the classification code corresponding to the stereo set 30 in accordance to the ID code of the stereo set 30 contained in the WiFi signals, and then converts the control command into the corresponding Bluetooth signals. Based on the classification code, the Bluetooth transceiver 26 is switched on to transmit the control command to the electric appliance corresponding to the ID code (i.e., stereo set 30), and the control process of the stereo set 30 is completed by the moment.

The way of setting up the air conditioner 40 is similar. In more details, the RF transceiving circuit 422 of the air conditioner 40 transmits the RF signals which contain all kinds of control information and the corresponding ID code of the air conditioner 40 to the RF transceiver 27 of the signal converter 20, and the ID code contained in the RF signals is stored into the memory 25 through the converting module 24, which also stores the classification code of the received signals (i.e., RF signals) into the memory 25, and establishes a connection between the classification code and the ID code corresponding to the air conditioner 40.

After that, the converting module 24 encapsulates the ID code and the control information into WiFi signals, which are then transmitted to the smartphone 10 through the WiFi transceiver 22. In this way, all kinds of the control information of the air conditioner 40 are shown on the display of the smartphone 10 for a user to select therefrom. Similarly, the air conditioner 40 can be controlled wirelessly as described above relating to the stereo set 30, except that the RF transceiver 27 is switched on instead in accordance to the classification code corresponding to the RF signals.

The method of setting up the TV 50 is basically the same with those of the aforementioned electric appliances 30, 40, except that the IR controller 52 is unable to send out IR signals. Therefore, the memory 25 is previously stored with a plurality of IR protocols and the classification code corresponding to the IR signals, wherein one of the IR protocols corresponds to the ID code and all kinds of control information of the TV 50. A user can select the IR protocol corresponding to the TV 50 by transmitting WiFi signals which contain a selecting command to the signal converter 20 through the smartphone 10. According to the selecting command, the converting module 24 extracts the IR protocol corresponding to the TV 50 from the memory 25, and encapsulates the control information and the ID code of the TV 50 into WiFi signals, which are then transmitted to the smartphone 10 through the WiFi transceiver 22.

After that, the display of the smartphone 10 shows all kinds of the control information of the TV 50 for a user to select therefrom. Once selected, the smartphone 10 transmits WiFi signals which contain the ID code and the related control command of the TV 50 to the signal converter 20. According to the ID code of the TV 50 contained in the WiFi signals, the converting module 24 of the signal converter 20 then extracts the classification code and the IR protocol corresponding to the TV 50 from the memory 25, and the control command is encapsulated into IR signals. Based on the classification code, the IR transmitter 28 is switched on to transmit the IR signals to the IR controller 52 to control the TV 50.

In summary, the remote control system 100 of the present invention sends out the WiFi signals according to the control commands inputted via the smartphone 10, and the signal converter 20 converts the WiFi signals into the Bluetooth signals, the RF signals, or the IR signals, which are then transmitted to each of the corresponding electric appliances. Whereby the electric appliances can be controlled at a remote distance. In other words, the remote control system 100 of the present invention is not only able to convert the WiFi signals into the Bluetooth signals, but also into the RF signals or the IR signals to meet different requirements, which improves the convenience of controlling several kinds of electric appliance.

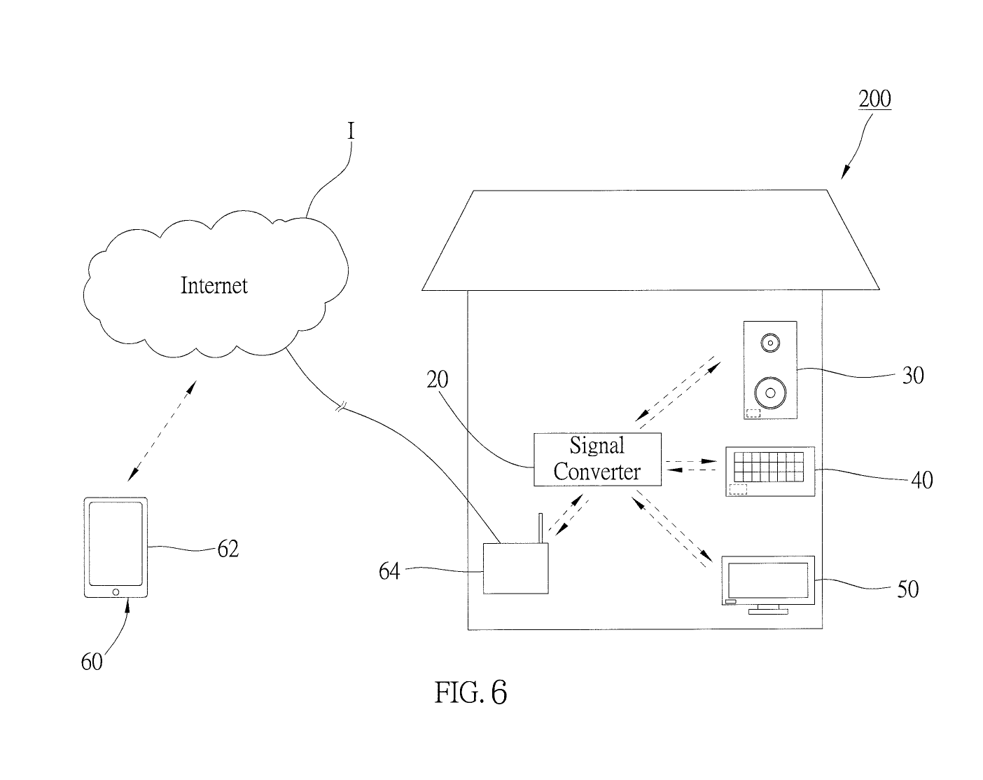

As shown in FIG. 6, a remote control system 200 of the second preferred embodiment of the present invention is basically the same with the aforementioned first preferred embodiment, except that the control signal source 60 includes an electronic device, which is a smartphone 62 as an example, and a wireless access point (AP) 64.

The smartphone 62 transmits signals which contain the control commands to the wireless AP 64 through an Internet I; the wireless access point 64 converts the signals into WiFi signals, and transmits the WiFi signals to the signal converter 20. The aforementioned process of converting the WiFi signals into the Bluetooth signals, the RF signals, or the IR signals is then taking place. In this way, a user who is at an outdoor location can still control each of the electric appliances through the smartphone 62, which greatly increases the communication distance between the electronic device and each of the electric appliances.

It must be pointed out that the embodiments described above are only some preferred embodiments of the present invention. All equivalent structures which employ the concepts disclosed in this specification and the appended claims should fall within the scope of the present invention.

What is claimed is:

1. A remote control system, comprising:
a control signal source which generates and sends out WiFi signals;
a signal converter including a WiFi transceiver, a converting module electrically connected to the WiFi transceiver, and a Bluetooth transceiver electrically connected to the converting module, wherein the WiFi transceiver receives the WiFi signals from the control signal source, and the converting module converts the WiFi signals into corresponding Bluetooth signals to be sent out by the Bluetooth transceiver; and
a first electric appliance including a Bluetooth transceiving circuit and a first control circuit electrically connected to the Bluetooth transceiving circuit, wherein the Bluetooth transceiving circuit receives the Bluetooth signals from the Bluetooth transceiver, and the first control circuit controls the first electric appliance to perform functions according to the received Bluetooth signals.

2. The remote control system of claim 1, further comprising a second electric appliance, which includes an RF transceiving circuit and a second control circuit electrically connected to the RF transceiving circuit, wherein the signal converter includes an RF transceiver electrically connected to the converting module, which converts the WiFi signals received by the WiFi transceiver into corresponding RF signals to be sent out by the RF transceiver; the RF transceiving circuit of the second electric appliance receives the RF signals from the RF transceiver of the signal converter, and the second control circuit accordingly controls the second electric appliance to perform functions.

3. The remote control system of claim 2, wherein the signal converter includes a memory, which is stored with ID codes respectively referring to the first electric appliance and the second electric appliance, and classification codes each representing different types of signals receivable by each of the electric appliances; the WiFi signals from the control signal source contain the ID code referring to one of the electric appliances; the converting module extracts the classification code from the memory which corresponds to the electric appliance referred by the ID code contained in the WiFi signals, and then switches on the Bluetooth transceiver or the RF transceiver according to the extracted classification code in order to transmit the corresponding Bluetooth signals or RF signals to the corresponding electric appliance.

4. The remote control system of claim 1, further comprising a third electric appliance, which includes an IR receiving circuit and a third control circuit electrically connected to the IR receiving circuit, wherein the signal converter includes an IR transmitter electrically connected to the converting module, which converts the WiFi signals received by the WiFi transceiver into IR signals to be sent out by the IR transmitter; the IR receiving circuit of the third electric appliance receives the IR signals from the IR transmitter of the signal converter, and the third control circuit accordingly controls the third electric appliance to perform functions.

5. The remote control system of claim 4, wherein the signal converter includes a memory, which is stored with ID codes respectively referring to the first electric appliance and the third electric appliance, and classification codes each representing different types of signals receivable by each of the electric appliances; the WiFi signals from the control signal source contain the ID code referring to one of the electric appliances; the converting module extracts the classification code from the memory which corresponds to the electric appliance referred by the ID code contained in the WiFi signals, and then switches on the Bluetooth transceiver or the IR transmitter according to the extracted classification code in order to transmit the corresponding Bluetooth signals or IR signals to the corresponding electric appliance.

6. The remote control system of claim 1, wherein the control signal source includes an electronic device and a wireless access point which communicates with the electronic device; the electronic device transmits signals which contain control commands to the wireless access point, which then converts the signals into the WiFi signals, and sends out the WiFi signals.

7. A signal converter, comprising:
a WiFi transceiver receives WiFi signals;
a converting module electrically connected to the WiFi transceiver, wherein the converting module converts the WiFi signals into corresponding Bluetooth signals to be sent out; and
a Bluetooth transceiver electrically connected to the converting module, wherein the Bluetooth transceiver transmits the Bluetooth signals to a first electric appliance.

8. The signal converter of claim 7, further comprising an RF transceiver electrically connected to the converting module, wherein the converting module converts the WiFi signals received by the WiFi transceiver into RF signals to be transmitted to a second electric appliance by the RF transceiver.

9. The signal converter of claim 7, further comprising an IR transmitter electrically connected to the converting module, wherein the converting module converts the WiFi signals received by the WiFi transceiver into IR signals to be transmitted to a third electric appliance by the IR transmitter.

10. The signal converter of claim 8, further comprising an IR transmitter electrically connected to the converting module, wherein the converting module converts the WiFi signals received by the WiFi transceiver into IR signals to be transmitted to a third electric appliance by the IR transmitter.
